(19) United States
(12) Patent Application Publication
(10) Pub. No.: US 2023/0406107 A1
(43) Pub. Date: Dec. 21, 2023

(54) LEVER SWITCH, DISPLAY CONTROL SYSTEM FOR VEHICLE, AND VEHICLE

(71) Applicant: TOYOTA JIDOSHA KABUSHIKI KAISHA, Toyota-shi (JP)

(72) Inventors: Toshihiko KOSUGI, Toyota-shi (JP); Shinji MATSUBARA, Toyota-shi (JP)

(21) Appl. No.: 18/317,161

(22) Filed: May 15, 2023

(30) Foreign Application Priority Data
Jun. 16, 2022 (JP) 2022-097650

(51) Int. Cl. B60K 37/06; B60K 37/02

(52) U.S. Cl. CPC B60K 37/06; B60K 37/02; B60K 2370/782; B60K 2370/143

(57) ABSTRACT

A lever switch includes a lever switch main body configured to be disposed at a front side, in a front-rear direction of a vehicle, relative to a steering wheel that steers the vehicle; and a switching portion that is provided at the lever switch main body and, in response to a touch by a vehicle occupant without the lever switch main body being moved, switches a mode of a light of the vehicle.

### CROSS-REFERENCE TO RELATED APPLICATION

This application claims priority under 35 USC 119 from Japanese Patent Application No. 2022-97650 filed Jun. 16, 2022, the disclosure of which is incorporated by reference herein in its entirety.

### BACKGROUND

### Technical Field

The present disclosure relates to a lever switch, a display control system for a vehicle, and the vehicle.

### Related Art

WIPO Patent Publication No. WO2019/194212 discloses a technology relating to a light switch for a vehicle that is formed as a combination switch capable of switching modes of lights that illuminate outside the vehicle.

In general, a light switch for a vehicle is disposed at a front side in a front-rear direction of a vehicle relative to a steering wheel and is provided at a distal end portion of a turn lever (a direction indicator) that is operated before a change in a progress direction of the vehicle.

A position of the light switch may be changed by twisting substantially in the front-rear direction of the vehicle. Positions of the light switch may include, for example, Off, Auto, Small, Headlight and the like.

In order to suppress interference with a hand when the hand is operating the steering wheel, the light switch for a vehicle (which is a lever switch) is disposed at a position that is distant from the steering wheel. However, when the light switch is made distant from the steering wheel, the light switch is correspondingly more difficult for fingers to reach.

Because the light switch for a vehicle has composite functions for which plural positions are provided, an outer diameter (thickness) of the light switch is larger than if the light switch had only a single function. When the outer diameter of the light switch is increased in this way, it becomes necessary to position the fingers at a location that is more distant from the steering wheel, and the light switch is even more difficult for the fingers to reach.

### SUMMARY

In consideration of the circumstances described above, an object of the present disclosure is to provide a lever switch that may improve operability in switching between modes of a light of a vehicle, and to provide a display control system for a vehicle, and the vehicle.

A lever switch according to a first aspect of the present disclosure includes a lever switch main body and a switching portion. The lever switch main body is disposed at a front side in a front-rear direction of a vehicle relative to a steering wheel that steers the vehicle. The switching portion is provided at the lever switch main body. In response to a touch by a vehicle occupant without the lever switch main body being moved, the switching portion switches a mode of a light of the vehicle.

That is, because the mode of the light may be switched by the vehicle occupant touching the switching portion, there is no need to move the lever switch main body. As a comparative example, when a lever switch main body is twisted to switch a mode of a light, it is necessary for a wrist of the vehicle occupant to turn (twist) along with the twisting of the lever switch main body. In the present disclosure, by contrast, because there is no need to twist the lever switch main body, there is no need to turn the wrist and operability may be improved.

In a lever switch according to a second aspect of the present disclosure, in the lever switch according to the first aspect, the switching portion is configured to include a touch sensor capable of sensing the touch by the vehicle occupant.

In the lever switch according to the second aspect, the switching portion includes the touch sensor, and a touch by the vehicle occupant can be sensed by the touch sensor. In contrast to a structure in which, as a comparative example, a touch by a vehicle occupant is detected by, for example, pressing of a button or the like, in the present disclosure there is no need to apply extra force. Thus, operability in switching the mode of the light is improved correspondingly.

In a lever switch according to a third aspect of the present disclosure, in the lever switch according to the second aspect, the switching portion is configured to be capable of switching the mode in accordance with a direction of tracing on the touch sensor by the vehicle occupant.

In the lever switch according to the third aspect, because the switching portion enables switching of the mode of the light in accordance with a direction traced by the vehicle occupant on the touch sensor, switching of the mode of the light simply by a single touch on the touch sensor is prevented. Therefore, miss operation when the touch sensor is touched accidentally may be suppressed.

In a lever switch according to a fourth aspect of the present disclosure, in the lever switch according to the second aspect, a permission switch that permits sensing by the touch sensor is provided.

In the lever switch according to the fourth aspect, because the permission switch that permits sensing by the touch sensor is provided, sensing by the touch sensor when the vehicle occupant accidentally touches the touch sensor may be prevented. Therefore, miss operation when the touch sensor is touched accidentally may be suppressed further.

In a lever switch according to a fifth aspect of the present disclosure, in the lever switch according to the fourth aspect, the sensing by the touch sensor is permitted by touches by the vehicle occupant on the permission switch and the touch sensor.

In the lever switch according to the fifth aspect, sensing by the touch sensor is permitted by the vehicle occupant touching the permission switch and the touch sensor. Therefore, even if, for example, the vehicle occupant touches the touch sensor in a state in which the permission switch is not touched, sensing by the touch sensor is prevented. Thus, miss operation when the touch sensor is touched accidentally may be suppressed further.

In a lever switch according to a sixth aspect of the present disclosure, in the lever switch according to the fourth aspect, the touch sensor is provided at one side face of the lever switch main body, and the permission switch is provided at another side face of the lever switch main body that is disposed at an opposite side of the lever switch main body from the touch sensor.

In the lever switch according to the sixth aspect of the present disclosure, the touch sensor is provided at the one side face of the lever switch main body, and the permission switch is provided at the other side face that is disposed at the opposite side of the lever switch main body from the side thereof at which the touch sensor is provided. Sensing by the touch sensor is specified to be permitted by the permission switch in accordance with a touch by the vehicle occupant.

That is, if the vehicle occupant touches the touch sensor in a state in which the permission switch is not touched, sensing by the touch sensor is prevented. Therefore, miss operation when the touch sensor is touched accidentally may be suppressed.

In a lever switch according to a seventh aspect of the present disclosure, in the lever switch according to the sixth aspect, a recess portion is formed at the lever switch main body, the recess portion being recessed from the other side face toward the one side face of the lever switch main body, and the permission switch is provided in the recess portion.

In the lever switch according to the seventh aspect, the recess portion is formed at the lever switch main body. The recess portion is recessed toward the one side face from the other side face of the lever switch main body. The permission switch is provided in the recess portion. Therefore, the position of the permission switch may be confirmed via the recess portion by a touch of the lever switch main body with a fingertip.

In a lever switch according to an eighth aspect of the present disclosure, in the lever switch according to the first aspect, the lever switch main body is formed in a cuboid shape.

In the lever switch according to the eighth aspect, because the lever switch main body is formed in the cuboid shape, an upper end of the lever switch main body is formed in a planar shape in the front-rear direction of the vehicle and the width direction of the vehicle.

If, for example, the lever switch main body were formed in a circular rod shape, the upper end of the lever switch main body would be formed in a linear shape in the width direction. Therefore, when a vehicle occupant intends to touch the upper end of the lever switch main body, the vehicle occupant would touch a position at the front side in the front-rear direction of the lever switch main body in comparison with the structure in which the lever switch main body is formed in the cuboid shape.

In the present disclosure, by contrast, the lever switch main body may be formed in the cuboid shape. Consequently, in contrast to the structure in which the lever switch main body is formed in the circular rod shape, a contact surface is present at the upper end of the lever switch main body and the rear side in the front-rear direction of the contact surface may be touched, that is, the side at which the steering wheel is disposed (which is the side at which the vehicle occupant is disposed) is touched. Therefore, reaching the contact surface of the lever switch main body with the fingers when switching the mode of the light of the vehicle may be easier, and operability may be further improved correspondingly.

In a lever switch according to a ninth aspect of the present disclosure, in the lever switch according to the first aspect, the lever switch main body is configured to be disposed at a distal end portion of a turn lever that is displaced by the vehicle occupant from a neutral position to an indicating position at a time of changing a progress direction of the vehicle while the vehicle is running.

In the lever switch according to the ninth aspect, the lever switch main body is provided at the distal end portion of the turn lever. In the present disclosure, because the lever switch main body is easier for the fingers to reach and operability is improved further, effects provided by the lever switch main body may be beneficially used even while the progress direction of the running vehicle is being changed.

A display control system for a vehicle according to a tenth aspect of the present disclosure includes: the lever switch according to any of the first aspect to the ninth aspect; a display unit that displays the mode of the light of the vehicle; and a display control section that causes the display unit to display an image corresponding to the mode.

In the display control system for a vehicle according to the tenth aspect, the lever switch, the display section and the display control section are provided. The modes of the light of the vehicle that are switched by the lever switch are displayed at the display section by the display control section as images corresponding to the modes. Thus, a mode of the light of the vehicle may be confirmed by seeing an image at the display section.

A vehicle according to an eleventh aspect of the present disclosure includes the display control system for a vehicle according to the tenth aspect.

In the vehicle according to the eleventh aspect, the mode of the light of the vehicle may be switched by a touch against the detection section, and after the switching, an image corresponding to the mode is displayed at the display section by the display control section.

As described above, in the lever switch, display control system for a vehicle, and vehicle according to the present disclosure, operability in switching within modes of the light of the vehicle may be improved.

### BRIEF DESCRIPTION OF THE DRAWINGS

FIG. 1 is a perspective view showing a front portion of a vehicle cabin according to a present exemplary embodiment, seen diagonally from the rear-right and from the upper side;

FIG. 2A is an elevation view showing a display portion of the vehicle according to the present exemplary embodiment;

FIG. 2B is a perspective view of a lever switch according to the present exemplary embodiment, seen diagonally from the rear-right and from the upper side;

FIG. 3A is a perspective view of the lever switch according to the present exemplary embodiment, seen diagonally from the rear-right and from the upper side;

FIG. 3B is a plan view showing a state in which principal portions of the lever switch according to the present exemplary embodiment are seen from the upper side;

FIG. 4 is a conceptual diagram for describing operation of a display control system for a vehicle according to the present exemplary embodiment;

FIG. 5 is a block diagram showing hardware structures of a display control device that structures a portion of the display control system for a vehicle according to the present exemplary embodiment;

FIG. 6 is a block diagram showing functional structures of a server of the display control device that structures the portion of the display control system for a vehicle according to the present exemplary embodiment;

FIG. 7 is a flowchart showing an example of a flow of processing in the display control system for a vehicle according to the present exemplary embodiment;

FIG. 8A is a plan view for describing operation of the lever switch according to the present exemplary embodiment;

FIG. 8B is a right side view for describing operation of the lever switch according to the present exemplary embodiment;

FIG. 9 is a perspective view showing a lever switch according to a comparative example;

FIG. 10A is a plan view for describing operation of the lever switch according to the comparative example; and

FIG. 10B is a right side view for describing operation of the lever switch according to the comparative example.

### DETAILED DESCRIPTION

Below, a vehicle 12 at which a display control system for a vehicle 50 according to an exemplary embodiment of the present disclosure is deployed is described using the attached drawings. The arrow FR that is shown where suitable in the drawings indicates a front direction in a front-rear direction of a vehicle (a direction in which a vehicle occupant faces), an arrow UP indicates an upper direction in a vertical direction of a vehicle, and an arrow OUT indicates an outer direction in a width direction of a vehicle. Below, where descriptions are given simply using the directions front, rear, upper, lower, left and right, unless otherwise specified, these represent front and rear in the front-rear direction of the vehicle, upper and lower in the vertical direction of the vehicle, and left and right in the width direction of the vehicle when facing in a progress direction of the vehicle.

=Display Control System for a Vehicle=

First, principal structures of the vehicle 12 according to the present exemplary embodiment are described.

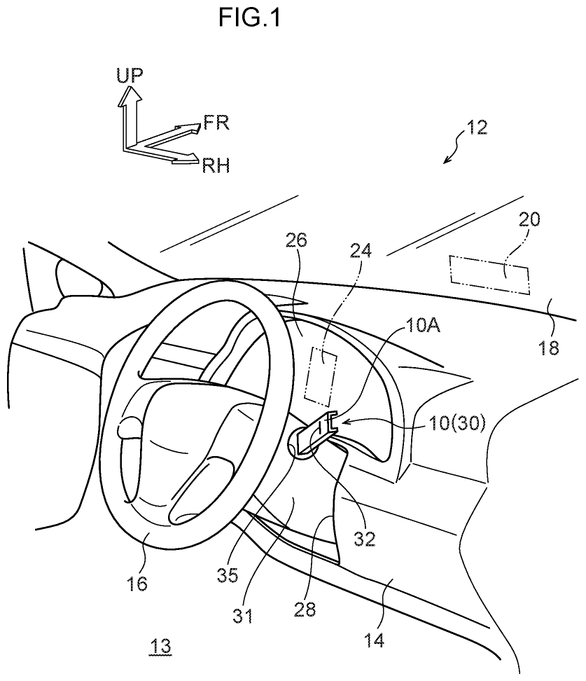

As shown in FIG. 1, an instrument panel 14 is provided at a front portion of the interior of a vehicle cabin 13 of the vehicle 12. A windshield glass 18 is provided at a front end portion of the instrument panel 14. The windshield glass 18 extends in the vertical direction and the width direction, and divides the vehicle cabin 13 interior from the vehicle cabin exterior.

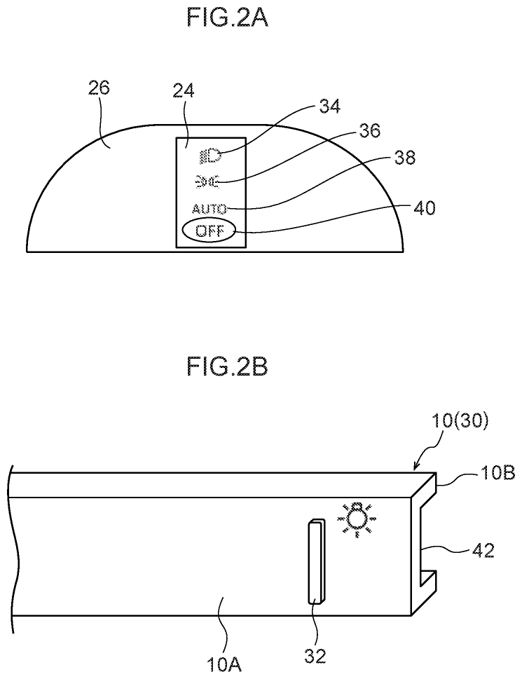

A display unit 20 is provided at the windshield glass 18. The display unit 20 is constituted by a projection surface that is projected onto by a head-up display (HUD) device 22 (see FIG. 2). The HUD device 22 is provided inside the instrument panel 14. The HUD device 22 is structured to project images onto the display unit 20 of the windshield glass 18.

A display unit 24 is provided at a lower side and at a rear side relative to the display unit 20. The display unit 24 is displayed at an instrument cluster 26. The instrument cluster 26 is located at a front of a driver seat at the instrument panel 14. The display unit 20 and the display unit 24 are each provided at positions that are viewable by a vehicle occupant. Note that the HUD device 22 and display unit 20 are not necessarily required.

The instrument panel 14 extends in the width direction. A penetrating hole 28 is formed at the right side of the instrument panel 14. A steering column (not shown in the drawings) extends through the penetrating hole 28 to inside the vehicle cabin 13. The steering column is disposed to be angled to the upper side toward the rear side. The steering wheel 16 is provided at a distal end of the steering column. The present exemplary embodiment is an example of a right-hand drive car in which the steering wheel 16 is provided at the right side and the driver seat is set at the vehicle right side.

At the front side relative to this steering wheel 16, a wiper switch lever that is not shown in the drawings is provided at the left side of the steering column and a turn lever 30, which is commonly referred to as an “indicator”, is provided at the right side of the steering column.

The outer periphery of the steering column is covered by a column cover 31. The wiper switch lever and the turn lever 30 are exposed to the inside of the vehicle cabin 13 through penetrating holes 35 formed at the column cover 31.

For example, a wiper switch and a washer switch are provided at the wiper switch lever. When the wiper switch is lowered by one step, the wiper switch is put into an “on” state. When the wiper switch is lowered by one more step, a wiping speed of a wiper becomes faster. When a vehicle occupant pulls the wiper switch lever toward themself, the washer switch is put into an on state and washer fluid is jetted out onto the windshield glass 18.

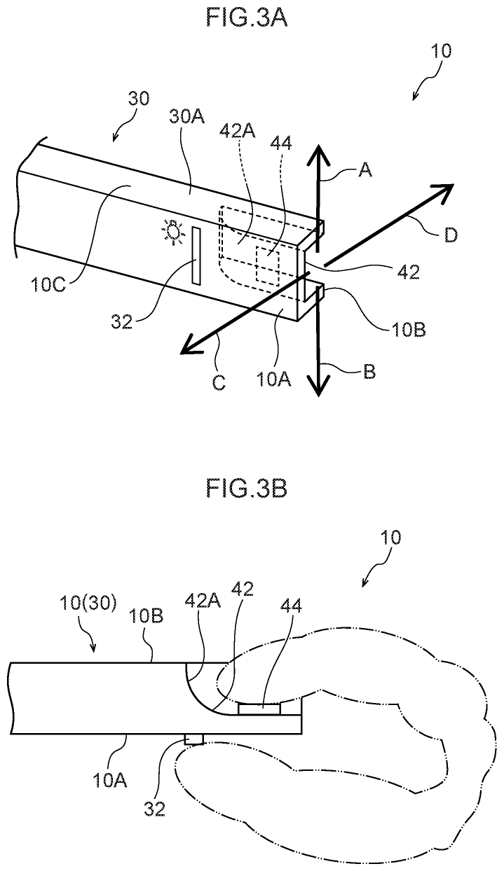

As illustrated in FIG. 3A, when the turn lever 30 is operated to turn toward the upper side (in the direction of arrow A) about the side thereof at which the steering column is disposed, which is not shown in FIG. 3A, a front indicator and rear indicator provided at the left side of the vehicle 12, which are not shown in the drawings, flash.

When the turn lever 30 is operated to turn toward the lower side (in the direction of arrow B) about the side at which the steering column is disposed, a front indicator and rear indicator provided at the right side of the vehicle 12, which are not shown in the drawings, flash.

When the turn lever 30 is pulled toward the vehicle occupant (in the direction of arrow C) about the side thereof at which the steering column is disposed, headlights, which are not shown in the drawings, are flashed. When the turn lever 30 is pushed away from the vehicle occupant (in the direction of arrow D), the headlights are set to high beam.

—Lever Switch—

Now, a lever switch (a lever switch main body) 10 is described.

The lever switch 10 is provided at a distal end portion 30A of the turn lever 30. When the lever switch 10 is put into an on state, switching of lights between on and off is enabled (described below).

In the present exemplary embodiment, as shown in FIG. 2A and FIG. 2B, a touch sensor (a switching portion) 32 is provided at a rear face (one side face) 10A of the lever switch 10. The touch sensor 32 that is employed is, for example, an electrostatic capacitance-type sensor. The touch sensor 32 is formed in a substantially rectangular shape and disposed with a length direction thereof in a vertical direction that is substantially orthogonal to a length direction of the lever switch 10. Modes of lights may be switched between by a vehicle occupant performing tracing actions on the touch sensor 32 along the length direction of the touch sensor 32 (a predetermined direction).

The modes of the lights may include, for example, Headlight, Small Light, Auto and Off. As shown in FIG. 2A, mode settings of the lights are, for example, Headlight 34, Small Light 36, Auto 38 and Off 40 in this order from the top. Headlight 34 and Small Light 36 are represented by symbols, and Auto 38 and Off 40 are represented by text.

In general, when the mode of the lights is switched to Auto, low beam lights and position lights (“small lamps”) are illuminated and extinguished in accordance with lighting levels outside the vehicle. In the Small Light mode, the low beam lights are extinguished and the position lights are illuminated. In the Headlight mode, the low beam lights and the position lights are illuminated.

In the present exemplary embodiment, as shown in FIG. 3A and FIG. 3B, the turn lever 30 is formed in a substantially cuboid shape. A recess portion 42 is formed at a front face (another side face) 10B of the lever switch 10. The recess portion 42 is recessed toward the rear face (one side face) 10A of the lever switch 10. The turn lever 30 is formed substantially in a U shape of which the front side is open in a cross section cut along a direction substantially orthogonal to the length direction of the turn lever 30.

A permission switch 44 is provided at the recess portion 42 of the front face 10B, which is disposed at the opposite side of the lever switch 10 from the touch sensor 32. A guide surface 42A is provided at a deeper side of the permission switch 44 (the side thereof at which the column cover 31 shown in FIG. 1 is disposed).

For example, a “touch sensor” of the electrostatic capacitance type is employed for the permission switch 44. When the permission switch 44 is touched, sensing by the touch sensor 32 provided at the rear face 10A of the lever switch 10 is permitted.

Therefore, when the touch sensor 32 is to be touched, a touch on the permission switch 44 is necessary. However, the touch sensor 32 and the permission switch 44 do not necessarily have to be touched at the same time. For example, switching the mode of the lights is possible even when timings of touches on the touch sensor 32 and the permission switch 44 are offset, provided the touches are within a predetermined duration set in advance.

In a state in which a vehicle occupant touches the touch sensor 32 and the permission switch 44, the vehicle occupant may switch the mode of the lights by performing a tracing action on the touch sensor 32.

As described above, the mode settings of the lights are Headlight 34, Small Light 36, Auto 38 and Off 40 in this order from the top (see FIG. 2A). Therefore, the mode may be switched in accordance with a tracing direction.

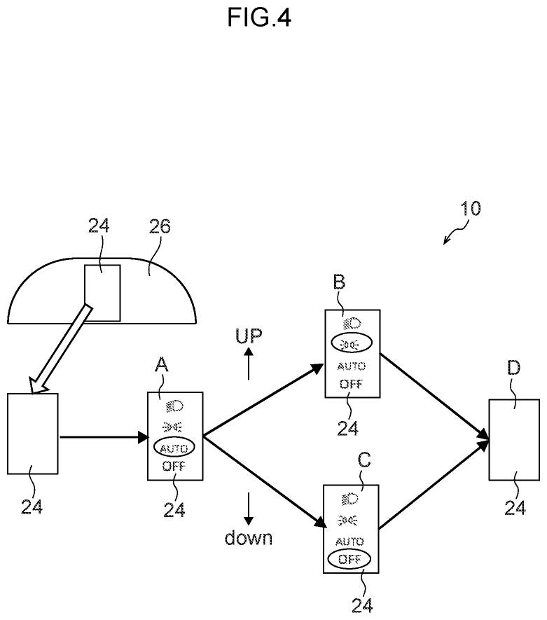

Describing this more specifically, as in the example shown in FIG. 4A, from a current mode (display A) of the display unit 24 displayed at the instrument cluster 26, when a trace on the touch sensor 32 is toward the upper side, a position of the mode settings is moved up (display B). On the other hand, when a trace on the touch sensor 32 is toward the lower side from the current mode (display A), the position of the mode settings is moved down (display C). When a predetermined duration set in advance has passed in a state after the mode has been switched, the display is erased (display D).

—Structures of the Display Control System for a Vehicle—

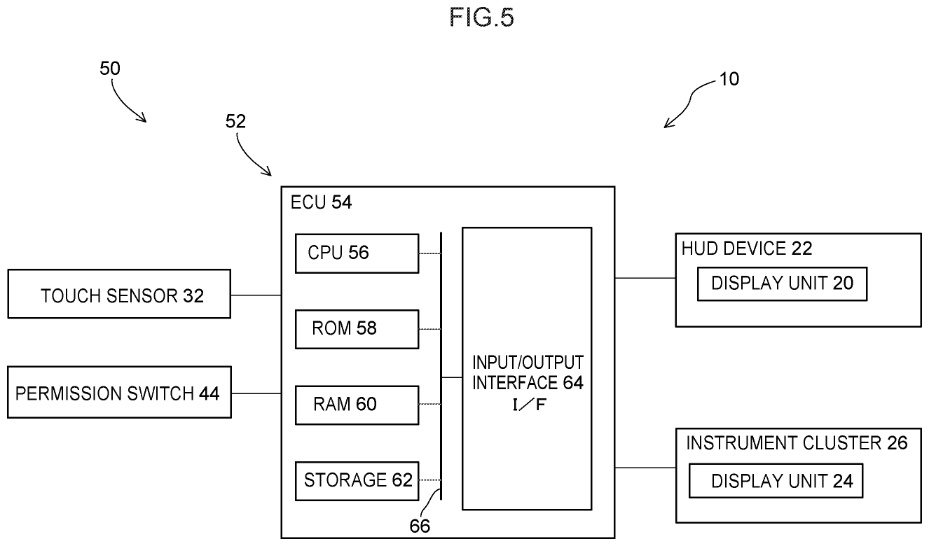

As shown in FIG. 5, the display control system for a vehicle 50 according to the present exemplary embodiment is equipped with a display control device 52.

The display control device 52 includes an electronic control unit (ECU) 54. The ECU 54 includes a central processing unit (CPU, which is a processor) 56, read-only memory (ROM) 58, random access memory (RAM) 60, storage 62 and an input/output interface 64. These structures are connected to be capable of communicating with one another via an internal bus 66.

The CPU 56 is a central arithmetic processing unit that executes various programs and controls respective parts. That is, the CPU 56 reads a program from the ROM 58 or the storage 62, and executes the program using the RAM 60 as a workspace. The CPU 56 performs control of the structures described above and various kinds of computational processing in accordance with programs recorded in the ROM 58 or storage 62.

The ROM 58 stores various programs and various kinds of data. The RAM 60 serves as a workspace, temporarily memorizing programs and data. The storage 62 is structured by a hard disk drive (HDD) or a solid state drive (SDD). The storage 62 is a non-transitory recording medium that stores various programs, including an operating system, and various kinds of data. In the present exemplary embodiment, the ROM 58 or storage 62 stores a display program and the like for implementing display processing. Various input/output devices are connected to the input/output interface 64.

This ECU 54 is electronically connected to each of the touch sensor 32, the permission switch 44, the HUD device 22 and the instrument cluster 26. When the vehicle occupant touches the touch sensor 32 and the permission switch 44, the ECU 54 detects touches according to the touch sensor 32. Hence, a current mode of the lights may be displayed by the display units 20 and 24.

—Functional Structures of the Display Control Device—

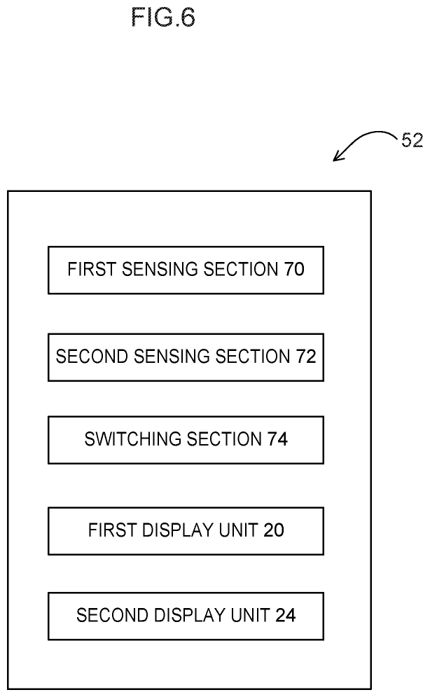

The display control device (display control section) 52 shown in FIG. 5 uses the hardware resources described above to realize various functions. The functional structures realized by the display control device 52 are described with reference to FIG. 6.

As shown in FIG. 6, as functional structures, the display control device 52 includes a first sensing section 70, a second sensing section 72, a switching section 74, and the display units 20 and 24. The functional structures are realized by the CPU 56 of the ECU 54 reading and executing a program.

The first sensing section 70 detects when a vehicle occupant touches the touch sensor 32, and the second sensing section 72 detects when the vehicle occupant touches the permission switch 44. The switching section 74 switches between the modes of the lights in accordance with tracing actions on the touch sensor 32. The display unit 20 displays a mode of the lights by projection onto the windshield glass 18, and the display unit 24 displays the mode of the lights at the instrument cluster 26.

=Operation and Effects of the Display Control System for a Vehicle=

Now, operation and effects of the display control system for a vehicle according to the present exemplary embodiment are described.

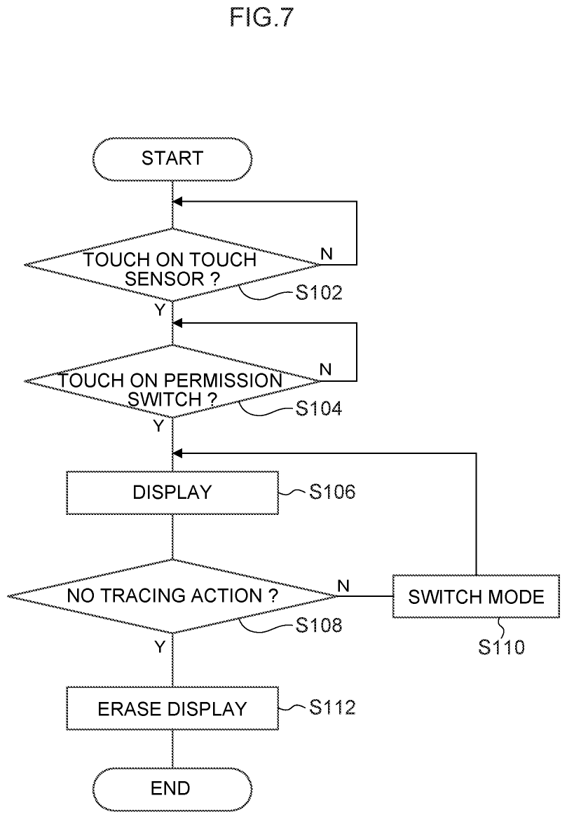

FIG. 7 is a flowchart showing an example of flow of the display processing by the display control device 52. This display processing is implemented by the CPU 56 of the ECU 54 reading a program from the ROM 58 or storage 62 shown in FIG. 5, loading the program into the RAM 60, and executing the program. Below, with reference to FIG. 5, the flow of display processing by the display control device 52 is described in accordance with the flowchart shown in FIG. 7.

As shown in FIG. 7, in step S102, the CPU 56 makes a determination as to whether an entry has been performed at the touch sensor 32 by a touch by a vehicle occupant or the like. The processing of step S102 is executed until an entry is performed at the touch sensor 32.

When the CPU 56 determines in step S102 that an entry has been performed at the touch sensor 32 (Yin step S102), the CPU 56 advances to the processing of step S104. In step S104, the CPU 56 makes a determination as to whether an entry has been performed at the permission switch 44 by a touch by the vehicle occupant or the like. The processing of step S104 is executed until an entry is performed at the permission switch 44. The processes of step S102 and step S104 may be reversed.

When the CPU 56 determines in step S104 that an entry has been performed at the permission switch 44 (Y in step S104), the CPU 56 advances to the processing of step S106. In step S106, the CPU 56 displays the current mode of the lights at the display unit 20 and the display unit 24.

Then, in step S108, the CPU 56 makes a determination as to whether a tracing action has been performed on the touch sensor 32. When the CPU 56 determines in step S108 that a tracing action has been performed on the touch sensor 32 (N in step S108), the CPU 56 advances to the processing of step S110. In step S110, the CPU 56 implements switching of the mode of the lights, and returns to the processing of step S106.

When the CPU 56 determines in step S108 that no tracing action has been performed on the touch sensor 32 (or that tracing actions have ended) (Y in step S108), the CPU 56 advances to the processing of step S112. In step S112, the CPU 56 erases the display of the mode of the lights at the display unit 20 and the display unit 24, and the flow of processing ends.

As described above, in the present exemplary embodiment, modes of the lights of the vehicle 12 may be switched by touches on the touch sensor 32.

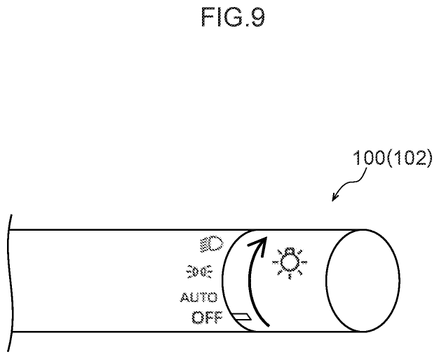

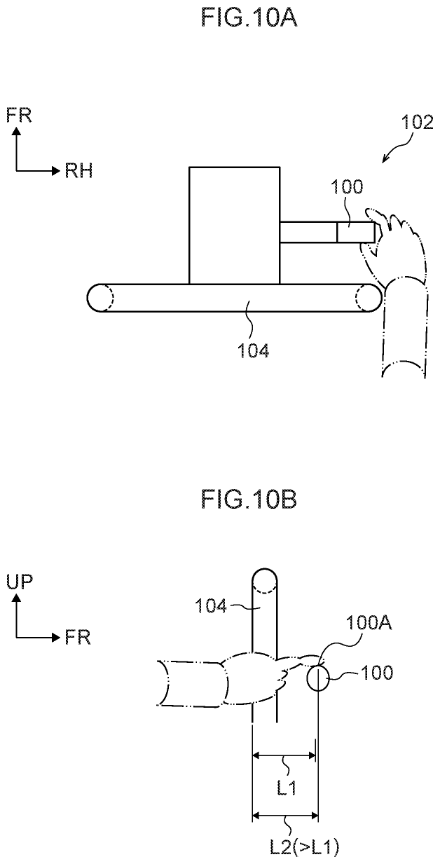

As a comparative example, as shown in FIG. 9, a lever switch 100 formed in a circular rod shape is twisted in the direction of the arrow to switch a mode of lights of a vehicle 102. With this structure, as illustrated in FIG. 10A, in a state in which a vehicle occupant is holding the lever switch 100, the vehicle occupant is required to turn their wrist from the side closer to the vehicle occupant (the side of the lever switch 100 at which a steering wheel 104 is disposed) to the side further from the vehicle occupant (in a direction away from the steering wheel 104).

In the present exemplary embodiment, by contrast, as illustrated in FIG. 3B, it is possible to switch the mode of the lights of the vehicle 12 without moving the lever switch 10, by touching the touch sensor 32. Therefore, there is no need to turn the wrist as in the comparative example and operability in switching the mode of the lights is improved.

In the present exemplary embodiment, because it is possible to switch the mode of the lights of the vehicle 12 by touching the touch sensor 32, in contrast to a structure in which, as an example that is not illustrated in the drawings, a button or the like is pressed, there is no need to apply extra force. Thus, operability in switching the mode of the lights of the vehicle 12 is improved correspondingly. Clearly, however, buttons or the like may be employed instead of the touch sensor 32 and the permission switch 44 that is structured by a kind of touch sensor.

If switching the mode of the lights of the vehicle 12 by touching the touch sensor 32 is possible, there is concern that the touch sensor 32 may be touched accidentally. Accordingly, in the present exemplary embodiment as illustrated in FIG. 4, the mode may be switched by tracing actions in predetermined directions on the touch sensor 32 (see FIG. 3A).

In this configuration, because the mode of the lights of the vehicle 12 is not switched when no tracing action is performed, unintended switching of the mode of the lights when the touch sensor 32 is touched accidentally is prevented. Therefore, in the present exemplary embodiment, miss operation when the touch sensor 32 is touched accidentally may be suppressed.

In the present exemplary embodiment, as shown in FIG. 3A and FIG. 3B, the touch sensor 32 is provided at the rear face 10A of the lever switch 10, and the permission switch 44 is provided at the front face 10B, which is disposed at the opposite side of the lever switch 10 from the touch sensor 32. The permission switch 44 is specified such that, when the permission switch 44 is touched by the vehicle occupant, sensing by the touch sensor 32 is permitted.

In a state in which sensing by the touch sensor 32 is not permitted by the permission switch 44, sensing by the touch sensor 32 when the vehicle occupant touches the touch sensor 32 is prevented. Therefore, in the present exemplary embodiment, the mode of the lights of the vehicle 12 is not switched just by a touch of the touch sensor 32. Thus, in the present exemplary embodiment, miss operation when the touch sensor 32 is touched accidentally may be suppressed further. However, note that the permission switch 44 is not necessarily required.

In the present exemplary embodiment, the recess portion 42 is formed at the lever switch 10, the recess portion 42 is recessed from the front face 10B toward the rear face 10A of the lever switch 10, and the permission switch 44 is provided in the recess portion 42. Therefore, in the present exemplary embodiment, the position of the permission switch 44 may be confirmed via the recess portion 42 by a touch of the lever switch 10 with a fingertip.

It is sufficient if at least the recess portion 42 is formed in the lever switch 10. Therefore, a general portion of the turn lever 30 other than the lever switch 10 may be formed in a substantially cuboid shape. In the present exemplary embodiment, the guide surface 42A is provided in the recess portion 42. Therefore, the guide surface 42A guides a fingertip of the vehicle occupant and makes confirming the position of the permission switch 44 easier. However, the guide surface 42A is not necessarily required. The recess portion 42 is also not necessarily required.

In the present exemplary embodiment, the lever switch 10 is formed in a cuboid shape. Therefore, an upper end 10C of the lever switch 10 is formed in a planar shape along the front-rear direction and the width direction. This “planar shape” does not necessarily have to be a flat shape but may be formed as a gently curved surface with a small curvature.

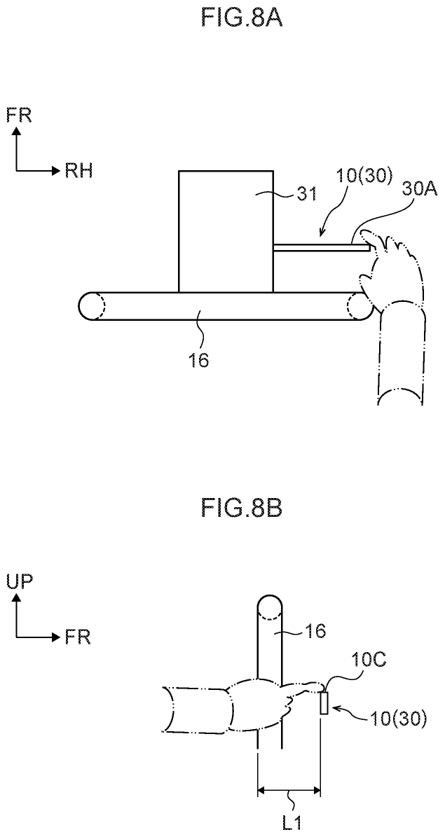

As a comparative example, as illustrated by the example in FIG. 10B, when the lever switch 100 is formed in the circular rod shape, an upper end 100A of the lever switch 100 is disposed in a linear shape along the width direction. Therefore, when a vehicle occupant moves to touch the upper end 100A of the lever switch 100, the vehicle occupant touches a position to the front side in the front-rear direction in comparison with the structure in which the lever switch 10 is formed in the cuboid shape as shown in FIG. 8B.

In the present exemplary embodiment, by contrast, the lever switch 10 is formed in the cuboid shape. Therefore, in contrast to a structure in which the lever switch 10 is formed in a circular rod shape, a contact surface at the upper end 10C of the lever switch 10 may be disposed to the rear side in the front-rear direction, that is, to the side at which the steering wheel 16 is disposed. Therefore, reaching with fingers when switching the mode of the lights of the vehicle 12 may be easier, and operability may be further improved.

When the lever switch 100 is formed in the circular rod shape as shown in FIG. 10A, an outer diameter (thickness) thereof is larger. Accordingly, a depth thereof in the front-rear direction is greater, and the lever switch 100 is more difficult for fingers to reach.

In the present exemplary embodiment, by contrast, as shown in FIG. 8A, because the lever switch 10 is formed in the cuboid shape, a plate thickness of the lever switch 10 may be reduced in a condition in which stiffness is assured. Thus, the lever switch 10 may be made easier for the fingers to reach.

The lever switch 10 is provided at the distal end portion 30A of the turn lever 30. Therefore, when the lever switch 10 is made easier for the fingers to reach and operability can be improved further, the same effects may be beneficially used even while the progress direction of the vehicle is being changed while the vehicle is running.

The display control system for a vehicle 50 according to the present exemplary embodiment is equipped with the lever switch 10, the switching section 74, the display units 20 and 24, and the display control device 52. Images corresponding to the modes of the lights of the vehicle 12 that are switched by operations of the lever switch 10 are respectively displayed at the display units 20 and 24 by the display control device 52. Therefore, a mode of the lights of the vehicle 12 may be confirmed by seeing the images at the display units 20 and 24.

In the vehicle 12 according to the present exemplary embodiment, when the touch sensor 32 and permission switch 44 are touched, the respective touches are detected by the first sensing section 70 and the second sensing section 72, and the mode of the lights of the vehicle 12 may be switched by the switching section 74. After the switching of the mode by the switching section 74, an image corresponding to the mode is displayed at the display units 20 and 24 by the display control device 52. Therefore, the mode of the lights of the vehicle 12 may be confirmed by seeing these images.

Because the images displayed at the display units 20 and 24 are soon erased, the images do not become a distraction during driving. Further, because it is sufficient that the mode of the lights of the vehicle 12 can be confirmed, the display units 20 and 24 are not necessarily required. For example, specification is possible such that the mode is displayed at the rear face 10A side of the lever switch 10.

The present disclosure is not limited to the exemplary embodiment described above. It will be clear that numerous modifications beyond the exemplary embodiment described above may be embodied within a technical scope not departing from the scope of the present disclosure.

=Additional Remarks=

The structures described below may be suitably combined to serve as the lever switch according to the present disclosure.

—Structure 1—

The lever switch is provided with: a lever switch main body configured to be disposed at a front side in a front-rear direction of a vehicle relative to a steering wheel that steers the vehicle; and a switching portion that is provided at the lever switch main body and, in response to a touch by a vehicle occupant without the lever switch main body being moved, switches a mode of a light of the vehicle.

—Structure 2—

The switching portion is configured to include a touch sensor capable of sensing the touch by the vehicle occupant.

—Structure 3—

The switching portion is configured to be capable of switching the mode in accordance with a direction of tracing on the touch sensor by the vehicle occupant.

—Structure 4—

The touch sensor is provided at one side face of the lever switch main body, and a permission switch is provided at another side face of the lever switch main body that is disposed at the opposite side of the lever switch main body from the touch sensor, the permission switch permitting sensing by the touch sensor in response to a touch by the vehicle occupant on the permission switch.

—Structure 5—

A recess portion is formed at the lever switch main body, the recess portion being recessed from the other side face toward the one side face of the lever switch main body, and the permission switch is provided in the recess portion.

—Structure 6—

The lever switch main body is formed in a cuboid shape.

—Structure 7—

The lever switch main body is configured to be disposed at a distal end portion of a turn lever that is displaced by the vehicle occupant from a neutral position to an indicating position at a time of changing a progress direction of the vehicle while the vehicle is running.

What is claimed is:

1. A lever switch comprising:
a lever switch main body configured to be disposed at a front side, in a front-rear direction of a vehicle, relative to a steering wheel that steers the vehicle; and
a switching portion that is provided at the lever switch main body and, in response to a touch by a vehicle occupant without the lever switch main body being moved, switches a mode of a light of the vehicle.

2. The lever switch according to claim 1, wherein the switching portion is configured to include a touch sensor capable of sensing the touch by the vehicle occupant.

3. The lever switch according to claim 2, wherein the switching portion is configured to be capable of switching the mode in accordance with a direction of tracing on the touch sensor by the vehicle occupant.

4. The lever switch according to claim 2, further comprising a permission switch that is configured to permit sensing by the touch sensor.

5. The lever switch according to claim 4, wherein the sensing by the touch sensor is permitted by touches by the vehicle occupant on the permission switch and the touch sensor.

6. The lever switch according to claim 4, wherein:
the touch sensor is provided at one side face of the lever switch main body, and
the permission switch is provided at another side face of the lever switch main body that is disposed at an opposite side of the lever switch main body from the touch sensor.

7. The lever switch according to claim 6, wherein:
a recess portion is formed at the lever switch main body, the recess portion being recessed from the other side face toward the one side face of the lever switch main body, and
the permission switch is provided in the recess portion.

8. The lever switch according to claim 1, wherein the lever switch main body is formed in a cuboid shape.

9. The lever switch according to claim 8, wherein the lever switch main body is configured to be disposed at a distal end portion of a turn lever that is displaced by the vehicle occupant from a neutral position to an indicating position at a time of changing a progress direction of the vehicle while the vehicle is running.

10. A display control system for a vehicle, comprising:
the lever switch according to claim 1;
a display unit that displays the mode of the light of the vehicle; and
a display control section that causes the display unit to display an image corresponding to the mode.

11. A vehicle comprising the display control system for a vehicle according to claim 10.
